(19) United States
(12) Patent Application Publication
(10) Pub. No.: US 2007/0264410 A1
(43) Pub. Date: Nov. 15, 2007

(54) Method for Optimising the Viscosity of Juices and Purees, in Particular for Tomatoes and Fruit

(75) Inventor: Gerardo Paciello, Zurich (CH)

Correspondence Address: LADAS & PARRY, 5670 WILSHIRE BOULEVARD, SUITE 2100, LOS ANGELES, CA, 90036-5679, US

(73) Assignee: CFT S.P.A., PARMA ITALY (IT)

(21) Appl. No.: 10/586,811

(22) PCT Filed: May 27, 2004
(86) PCT No.: PCT/IT04/00313

§ 371 Date: Mar. 8, 2007

(30) Foreign Application Priority Data
Jan. 30, 2004 (IT) PR2004 A 000006

(51) Int. Cl. A23L 2/02

(52) U.S. Cl. 426/599

(57) ABSTRACT

A method for optimising the viscosity of edible juices and purees, of the type comprising the steps of: sorting (1) the product; triturating (2) the product; heating (3) the triturated product; refining (4, 5) in one or more stages, obtaining a juice or puree (9), waste (6) and fibres (8), is characterised in that it comprises at least one of the following steps: recirculating (12) a part of the refined juice or puree to enter the triturating step or to enter the heating step; recirculating a part of the fibres (9) to enter the triturating step; stationing (16) the heated product, before the step of refining.

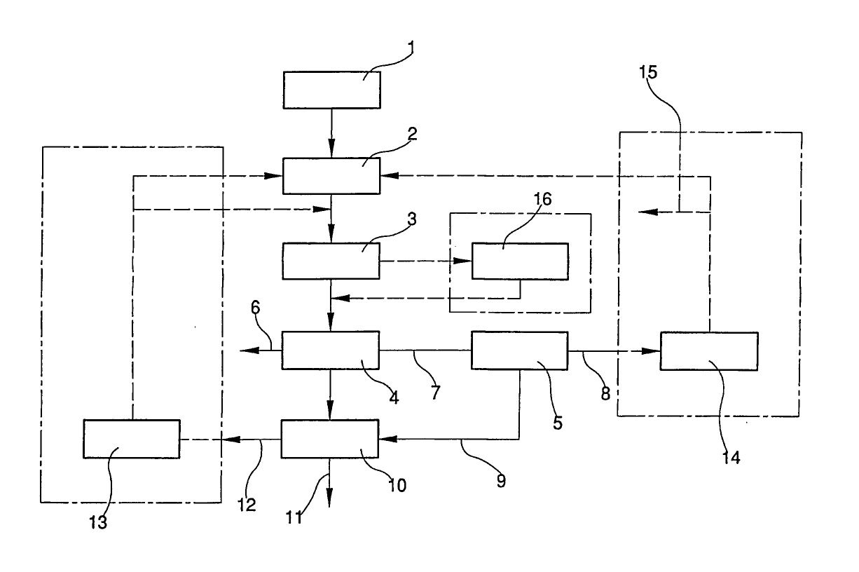

### TECHNICAL FIELD AND BACKGROUND ART

The present invention relates to a method for optimising the viscosity of juices and purees, to be used in particular for tomatoes and fruit.

The production of vegetable purees or fruit necessarily requires a step of heating to appropriate temperatures, both for enzymatic inactivation and for a partial lowering of the initial charge of micro-organisms present in the product. In particular, the step of producing the tomato concentrate comprises two possible distinct heating steps: “hot break” (heating to a high temperature (80-100° C.), necessary for lowering the pectolytic enzymes naturally present in tomatoes) or “cold break” (heating to a moderate temperature (50-65° C.), thereby allowing the action of the pectolytic enzymes naturally present in tomatoes).

The main consequence of such treatments is a different viscosity of the juices, higher for hot break juices and lower for cold break juices.

The “cold break” process comprises the following steps:
sorting the product;
finely triturating the product in a hammer triturator;
heating the triturate in a tubular plant with direct passage (thus, without triturate recirculation) at a temperature of about 50-65° c.;
refining in one or more stages, by means of sets of single or dual stage refiners;
collecting the juice in a tank for any subsequent steps.

In practice, the triturate is simply heated at intermediate (i.e. not too high) temperatures and refined, and the resulting product is a low viscosity concentrate.

The “hot break” process comprises instead the following steps:
sorting the product;
heating the product, either whole or weakly lacerated, in a closed-circuit heater with centrifugal pump which triturates whilst it provides for recirculation, and with a very high ratio between recirculation flow rate and feed flow rate, from 5 to 50 times, to assure an immediate heating of the tomatoes as soon as it enters the closed circuit;
refining;
collecting the juice in a tank for any subsequent steps.

For economic reasons, unique plants are generally built which operate in the two different conditions according to the selected method (Hot or Cold Break).

Another system for correcting the viscosity of the juice consists of adding to the juice itself a variable proportion of pulp (obtained therefrom or from other juice through a centrifuging operation, or obtained from a centrifuging operation on the waste of the refining process, which may be pre-treated in a turbo-press).

However, this gives rise to some drawbacks.

In the first place, the considerable recirculation is accomplished with pumps having high head and capacity, hence with considerable installed electrical powers.

A second drawback is that configuration changes (hot-cold break and vice versa) require idling the plants and disassembling-assembling components.

A third drawback is that, in order to obtain high viscosity Hot Break juices, temperatures must be raised to 95-100° C. with high energy consumption.

A fourth drawback is given by the occasional impossibility to obtain high viscosity levels acting only on temperature (influenced by the variety of fruit or vegetable).

Lastly, the method that requires adding or eliminating pulp, necessarily requires a centrifuging step, hence with two steps: pulp and clarified juice; recovering the juice, if one does not want to lose its totality, necessarily requires the availability of another independent processing line whereto said clarified juice is to be sent.

### DISCLOSURE OF INVENTION

The object of the present invention is to overcome the aforesaid drawbacks, making available a method for optimising the viscosity of juices and purees that is simple and economical.

Said objects are fully achieved by the method of the present invention, which is characterised by the content of the appended claims.

In particular, the method comprises at least one of the following steps:
recirculating a part of the refined juice or puree to re-enter the triturating step or to re-enter the heating step;
recirculating a part of the fibres to re-enter the triturating step;
stationing the heated product, before the step of refining it.

### BRIEF DESCRIPTION OF DRAWINGS

This and other features shall become more readily apparent in the following description of some preferred embodiments, illustrated by way of non limiting example in the accompanying drawing table, in which the single FIGURE illustrates the block diagram of the method.

### BEST MODE FOR CARRYING OUT THE INVENTION

With reference to the FIGURE, showing the block diagram of the present method, the number 1 indicates a step of sorting the product, typically tomatoes or fruit or vegetables, following by a trituration 2 which precedes a heating 3, preferably in a known direct passage heater, to a temperature of 65-85° C.

The triturated and heated product is then sent to a first refining stage 4, wherefrom exit waste 6 and an intermediate product 7 which is sent to a second refining stage 5 wherefrom exit fibres 8 and a juice or puree 9 that is sent to a collection step 10 in a tank before subsequent steps 11.

The method of the present invention is based on the consideration that the viscosity of edible purees and juices does not depend only on temperature, but also on the maximum fibre content attainable during the heating and refining steps.

Moreover, oftentimes a simple superficial scorching can be sufficient for a complete inactivation of the enzymes, with no need for mass inactivation.

Therefore, the heating system used is known, as are the refiners and the triturator, whilst some steps of the method vary in original fashion, according to different operative possibilities.

In a first embodiment, for the production of puree with high viscosity and low heat stress, a portion 12 of already refined juice or puree (generally, between 5 and 25% of the total juice or puree) is sent directly to the triturator through a pump 13.

Said juice derives from a heating to a temperature (65-85° C.) that is lower than traditional ones for hot break production (90-100° C.).

Moreover, said juice is a product which, unlike the triturate (used in the prior art) has undergone a complete enzymatic inactivation (whilst the triturate, being a non homogeneous product, may have not bee completely inactivated during recycling) and a thorough refinement (no pieces are present and morphology is uniform with the absence of seeds or stalks).

During trituration, the hot juice provided an immediate superficial enzymatic inactivation of the part of fruit or vegetable that was broken during trituration, leaving unaltered the enzymes present in mass in unbroken parts. Moreover, the presence of said liquid phase (the juice) enables a more rapid and uniform heating in the heater.

In a second embodiment, in the second refining stage 5, the second refiner has a smaller sieve (i.e. with finer mesh) than the first stage 4, thereby discarding not the seeds, stalks and peel (which are discarded by the first stage) but only fibre 8 (generally equal to 2-3% of the flow rate feeding the sorting operation) which can be recycled by means of a pump 14 in part or in full into the triturator (a possible overflow 15 is provided by means of a valve or pump, not shown), amalgamating with the triturate and passing in solution in the juice during the subsequent heating and refining step. The result will then be a juice or puree that is more enriched with cellulose components which are responsible for viscosity increases.

According to an alternative embodiment or in addition to what is described above, the juice or part thereof, with a spraying system can be sprayed onto the triturate immediately after the triturator (generally, a buffer tank is present).

According to a further embodiment, alternative or additional to what is described above, the triturate, after heating, undergoes a stationing 16 for a time variable from 0 to 30 minutes in a tank of in a tube, before the first refinement.

This allows an additional cooking of the product, which facilitates the work of the refiners and lets more fibre pass into the juice, thereby increasing its viscosity.

As explained above, the various embodiment can be simultaneous or alternative, i.e. one or more of the solutions described above can be present in the method.

Moreover, the triturator could be replaced by a single joint cutting and refining set (turbo-extractor) in which, simultaneously with the cutting step, there is a sifting of different grain size (different sieve) which allows a perfect amalgamation of the fibres with the main product.

With the present method, since there triturate is recycled but only refined and inactivated juice, it is not necessary to use pumps of high capacity and size.

It also allows to obtain a “hot break” product but at lower temperature, increasing process efficiency (fibres are not discarded but recycled) and providing the final product with better taste and quality.

Fibre dosage allows to regulate the viscosity of the final product. A further advantage is given by the possibility of avoiding the use of decanters to enhance product viscosity. The prior art using decanters forces to use two production lines at the same time, a hot break line and a cold break line, with the drawback of a considerable loss of product and poor efficiency.

1. A method for optimising viscosity of edible juices and purees, comprising:
sorting a product;
triturating the product;
heating the triturated product;
refining in one or more stages, obtaining a juice or puree, waste and fibres;
feeding a part in a percentage of 5-25% of the refined juice or puree to undergo further trituration or further heating;
recirculating a part of the fibres to undergo further trituration;
stationing the heated product before said refining, said stationing having a duration of about 0-30 minutes and occurring in a tank or tube.

2. (canceled)

3. A method as claimed in claim 1, wherein said feeding occurs by spraying or nebulisation.

4-7. (canceled)
